(19) United States
(12) Patent Application Publication
(10) Pub. No.: US 2005/0076377 A1
(43) Pub. Date: Apr. 7, 2005

(54) System and method for compact disc and packaging composition and formatting

(76) Inventors: Gary S. Nuell, Santa Monica, CA (US); Robert B. Parzek, Nassau, NY (US)

Correspondence Address: AKIN GUMP STRAUSS HAUER & FELD, LLP, P O BOX 688, DALLAS, TX, 75313-0688, US

(21) Appl. No.: 10/887,987

(22) Filed: Jul. 9, 2004

Related U.S. Application Data
(60) Provisional application No. 60/485,994, filed on Jul. 10, 2003.

(51) Int. Cl. H04N 7/173; G06F 17/60; H04N 5/445; G06F 3/00; G06F 13/00

(52) U.S. Cl. 725/87; 705/26; 705/27; 725/86; 725/61

(57) ABSTRACT

A system for delivering content is provided that comprises a content selection system receiving one or more content selections from a user and assembling the content selections. A content delivery system assembles the content selections with one or more content deployment system. The content selections and the content deployment systems are delivered as an integrated unit.

### RELATED APPLICATIONS

This application claims priority to U.S. provisional patent application 60/485,994, filed Jul. 10, 2003, which is hereby incorporated by reference for all purposes.

### FIELD OF THE INVENTION

The present invention pertains to the field of audio and video data delivery systems, and more specifically to a system for composition and formatting of a compact disc, DVD, or other suitable media and that also formats the packaging for the media.

### BACKGROUND OF THE INVENTION

Systems for formatting audio and/or video data onto media are known in the art. Although such systems allow users to store audio and/or video data, they do not also allow the user to readily print packaging for the media that matches the audio and/or video data. As a result, users are unlikely to utilize such existing systems, as it is difficult to track such media without clear labeling that identifies what is recorded on the media.

### SUMMARY OF THE INVENTION

In accordance with the present invention, a system and method for compact disc and packaging composition and formatting are presented that overcome known problems with component inspection.

In particular, a system and method for compact disc and packaging composition and formatting are presented that allow such media to be readily recorded and for labels to be readily provided.

In accordance with an exemplary embodiment of the present invention, a system for delivering content is provided that comprises a content selection system receiving one or more content selections from a user and assembling the content selections. A content delivery system assembles the content selections with one or more content deployment system. The content selections and the content deployment systems are delivered as an integrated unit.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for content delivery and packaging in accordance with an exemplary embodiment of the present invention;

FIG. 2 is a diagram of a system for content delivery and packaging in accordance with an exemplary embodiment of the present invention;

FIG. 3 is a diagram of packaging in accordance with an exemplary embodiment of the present invention;

FIG. 4 is a diagram of packaging in accordance with an exemplary embodiment of the present invention;

FIG. 5 is a diagram of packaging in accordance with an exemplary embodiment of the present invention, showing the first two steps for assembling the packaging;

FIG. 6 is diagram of packaging in accordance with an exemplary embodiment of the present invention, showing the next three steps for assembling the packaging; and

FIG. 7 is diagram of packaging in accordance with an exemplary embodiment of the present invention, showing the last two steps for assembling the packaging.

### DETAILED DESCRIPTION OF THE INVENTION

In the description that follows, like parts are marked throughout the specification and drawings with the same reference numerals, respectively. The drawing figures are not necessarily to scale, and certain components can be shown in generalized or schematic form and identified by commercial designations in the interest of clarity and conciseness.

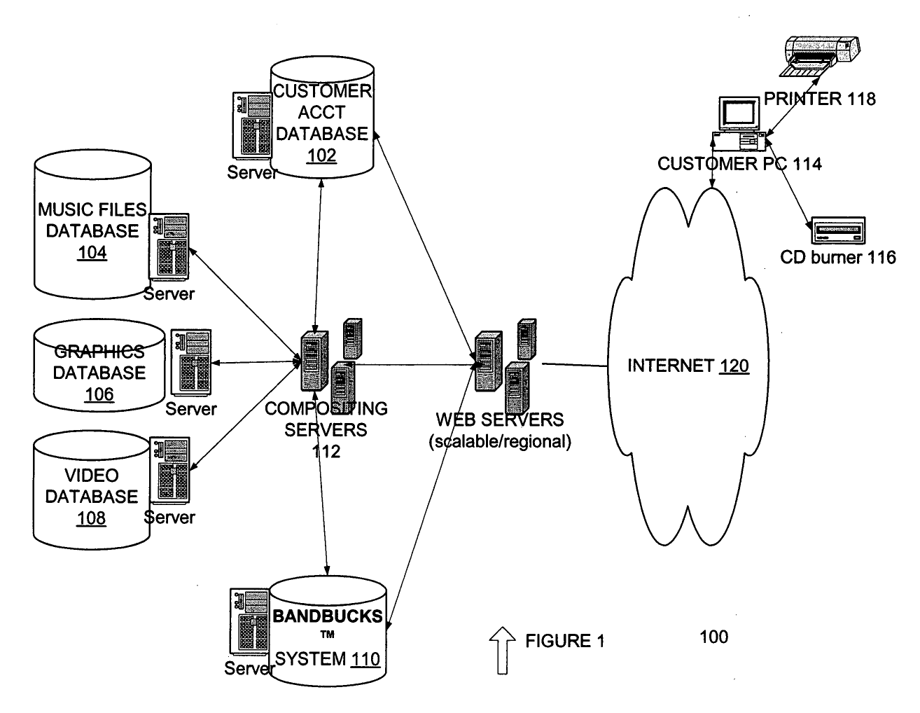

FIG. 1 is a diagram of a system 100 for content delivery and packaging in accordance with an exemplary embodiment of the present invention. A run-time, executable file, including proprietary code and a payload of multiple media elements (files or other data structures), which may include music, video, text, graphics, and animation that, upon download to a recipient's computer 114, can be “run” to facilitate a suitable user-selected process, in its initial creation.

By running this exemplary playLOAD™ file the user initiates a final delivery process that can install the necessary “compiled” media components onto the user's machine (including but not limited to a GUI for navigating the contents of the file and playing them), initiate a print job (of media artwork or other visual elements) and initiate a media authoring process (CD burning, DVD burning, or transfer to a digital media player).

This entire process can be initiated for delivering suitable media content to an end user via one, singular, self-sufficient file. While other components can enhance the utilization of this file (external third party media players and authoring tools), they are not necessary for the end user to acquire the media elements contained within, or author the files onto blank media.

A playLOAD™ file can start out as a group of cross linked systems which are integrated for the playLOAD™ file creation process.

These systems can each have a role in the creation process and can be capable of intercommunication via current networking topologies or some future transmission facility. The networking topologies can change, and these systems can linked to facilitate integration.

The process of creating a playLOAD™ file can be triggered by a suitable set of initiated processes or events. One exemplary “trigger” for this creation can be an end-user request. The end user can assemble the components of a file, such as by adding items to a shopping cart or in other suitable manners. Upon assembling their “list” of media elements, they can confirm and begin the file creation process.

The entire system, as previously stated can be comprised of internetworked components, such as front-end systems (those responsible for directly interfacing with the end-user and outside world) which can be responsible for providing customers with an interface to browse and select the content available to them, an interface for account administration and all necessary tools for the final customized file creation and delivery, and back-end systems (those systems that do not interface with the end-user directly, but rather handle the administration and engineering tasks over private networks) which can be responsible for authorizing customers, processing orders, managing and distributing media, tabulating metrics from end-user functions, compiling the final playLOAD file from media databases, checking integrity and finally, delivering to the end-user.

This is an exemplary overview of the concepts and ideas that comprise the PlayLOAD™ media distribution and purchasing system. In one exemplary embodiment, the integration of multiple sources and types of media, the use of a specialized PlayLOAD™ printable blank template product, the BANDBUCKS™ system 110 (a value-added structure of customer rewards), and a method to get the media files, artwork and multimedia components bound together, in a single file and delivered to the end user—and into or onto the blank media of their choice can be provided.

The system is easier than prior art systems for downloading files and storing them to suitable media. No one part of the system is wholly dependent on the other, making this scalable and robust enough to withstand the demands of a global marketplace.

Because the end user wants to experience the least amount of hassle when purchasing music or media online, when using the PlayLOAD™ service, the user can buy an entire album of music and only needs to download one single file, which could contain all of the music, multimedia footage, cover/CD artwork, and peripheral control systems (such as printer controllers and CD or DVD burner controllers). This integrated file, essentially this package, is a payload—or “PlayLOAD™ file”.

In one exemplary embodiment, after the PlayLOAD™ file is successfully delivered to the user, the file expands or unzips itself and begins to create both the artwork and the CD containing the user's selected files. Prior to running the file, the user can place a blank template in their printer 118 and a blank CD in their CD, DVD, or other suitable media burner 116. Both the blank template and CDs could be made available in an integrated package having a suitable number of blanks. This template package could also contain a coupon to download some music free of charge so that users can test the system to prove its ease of use.

There are several exemplary components, which comprise this system in whole or in part:

The Internet 120—as a means of file transmission, interaction and order placement

The raw music and media files—these are files in their standard MP3 or video format—as they are today.

The PlayLOAD™ interface (web site)—the main portal for interacting and utilizing the PlayLOAD™ service

The BANDBUCKS [symbol] system 110—the value added service that provides customers with incentives and promotions centered on utilizing PlayLOAD™

The PlayLOAD™ template kit—specialized blank templates produced in partnership with an existing distributor of blank CD-Rs and labeling systems. These would be easy to use, print on, and fold into any custom CD sleeve.

The customer accounts database 102 can keep track of customer account records, preferences, history and profiles. For instance, when a customer first logs on to the site, this database can keep track of the types of music that they enjoy most, maintain all of the necessary account info which will allow the customer to purchase media on the fly (such as credit card info and a cross-link to the BANDBUCKS™ database), and perform other suitable functions.

Customers can have the option of either using their BANDBUCKS™ credit for purchasing more media using the PlayLOAD™ system, they can cash out the BANDBUCKS™ credits in promotional offerings such as discounts on concert tickets, or they can perform other suitable functions.

The music files database 104 can include a repository or library of encoded media, which can be maintained by the PlayLOAD™ system or other suitable systems. This database can also be complemented by the ability of the system to pull media files from databases maintained by other companies, i.e. a large record label who has established a distribution relationship with PlayLOAD™. That way, the end user has access to a vast array of media, without requiring the PlayLOAD™ system to actually maintain storage for all the media it provides.

The graphics database 106 contains graphics files that can comprise the front and back of the end-users printed packaging. One of the exemplary parts of this system is the use of a template that the end-user can purchase in a local retail store. This template can be easy to use in a variety of printers so that the entire process of delivering the PlayLOAD™ and executing the file is simple and easy to use. For instance, say an artist wants to release a full-length album via the PlayLOAD™ system. The artist could have the option of providing the user with a selection of “album covers” and as the user selects the songs they want included in the PlayLOAD™ file, they can also choose a customized or favorite album cover. These aspects of the PlayLOAD™ system are optional and scalable, but may be features that provide the customer with a value added experience that keeps them coming back for more.

The video database 108 allows multiple types of media to be integrated into the PlayLOAD™ system can also be used, so that the end-user does not have to go to multiple places on the Internet to gather media. While the user is selecting song files that they wished to include in the PlayLOAD™ file the system can be informing them of the availability of alternate related media which they may be interested in, such as broadcast music videos, exclusive content, candid content, behind the scenes footage of studio sessions, or other suitable content could also be offered. In one exemplary embodiment, some of these files could be offered for sale, or they could be incorporated into promotional offers, where the user is required to purchase a certain number of songs. Once they have purchased the songs, it could unlock special video of their favorite artist, showing the recording process or maybe bloopers and outtakes. The ability for the user to customize their experience, if they so choose, can make this service something as personal as their musical tastes themselves.

The BANDBUCKS™ system 110 allows the user to accumulate “points”, for using the PlayLOAD™ service or to be rewarded for purchasing music or other items. This server would be similar to a credit card transactions system, however it could also or alternatively use a fictional currency called BANDBUCKS™. When the user purchases a song, that song is given a BANDBUCKS™ value. As the consumer purchases more songs, they accumulate BANDBUCKS™, and the total amount of BANDBUCKS™ is constantly updated and made easy to see for the user. That way, as the user cruises the system and selects music files they can instantaneously see how much value they are accumulating in BANDBUCKS™. This system can prompt the user to stay on the PlayLOAD™ system longer and purchase more music regularly. The BANDBUCKS™ can be used in a variety of ways. One such way would be to provide the consumer with a discount coupon for the live show of their favorite artist as it comes to their town. Another way would be to allow the user to cash out their BANDBUCKS™ by purchasing more music, making the customer feel empowered and avoiding the feeling of being prodded by a large corporation. The consumer has become much more savvy and is much more aware of the methodologies employed by companies to push them toward specific products. The present invention can make these marketing strategies as unobtrusive as possible. This system could also be used as an incentive to get the user to participate in viewing market specific ads or participate in consumer surveys *should they choose* in exchange for BANDBUCKS™.

One or more compositing servers 112 can be used to take the customer order (the list of the items they want in their payload) and bind them together with the appropriate graphics and run-time components. The servers fulfill the creation of the payload file. Once the payload file has been created, it is placed on a secure directory on the front-end Web servers for download by the user. This system can also be incorporated into any “push topology” where the file is actively sent to the end-user via client software (such as an existing file sharing system). The distributed architecture of the PlayLOAD™ service can be used to scale and upgrade separate components as necessary.

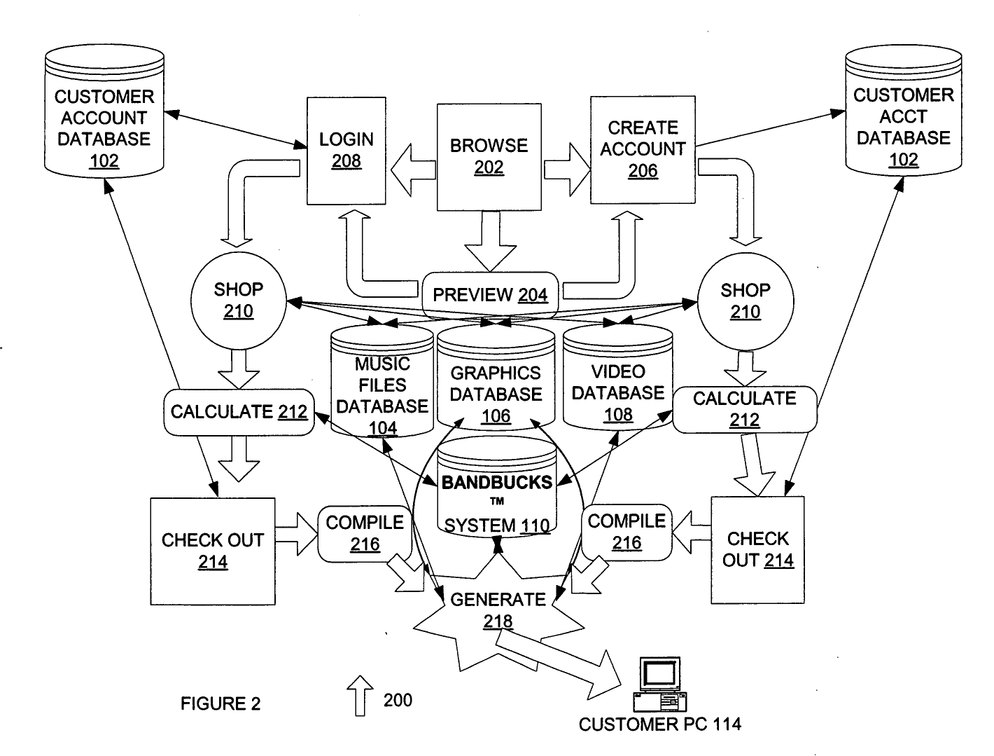

FIG. 2 is a diagram of a system 200 for content delivery and packaging in accordance with an exemplary embodiment of the present invention

At 202, the user, upon hearing about the PlayLOAD™ service goes to the main web site, or portal. There, they are greeted by a clean, easy to understand interface. Minimizing the amount of banner ads and Vegas-style advertising on this main page can also make the user feel as though they are not going to be subjected to just one more “market analysis study”.

The main site provides links to further explain how the PlayLOAD™ system works and how its revolutionary processes will make buying music and media a fun and easy experience. There can be a multimedia tour guide that the user can view which will actually show with pictures, animation and sound, the entire process behind using the PlayLOAD™ system.

If the user isn't interested in immediately creating a user account with the PlayLOAD™ system, they can be provided at 204 with the option of browsing the entire catalog of media available to them and even of going through the process of creating a PlayLOAD™ file without actually giving up any of their personal information.

Integration with standard credit card transaction companies as well as payment systems such as PayPal could also be provided. Throughout this entire process the user can also be able to see how many potential BANDBUCKS™ they have accumulated. There can be a BANDBUCKS™ “counter” window prominently displayed so that the user is always aware of the value they were adding to their experience. All of this can be accomplished without requiring the user to enter personal info. If the user does in fact decide to order the custom payload file they have just created, they can then set up an account at 206 or log in to an existing account at 208 and return to their “shopping cart” and pick up where they left off. This process can allow them to enter their credit card and personal info at the end of the content selection and still be able to immediately download and use the PlayLOAD™ file they have created.

If the user doesn't have any of the template materials, when the PlayLOAD™ file is executed on the user's machine, it can ask them “are you using a PlayLOAD™ template?”. If the user chooses “no”, then the PlayLOAD™ file can burn a generic CD and print a generic version of the album graphics on normal printer paper. The graphics can also be printed on normal paper and crop marks and fold marks can be provided so that the user could make a CD sleeve.

During the shopping process 210, the user's browsing and shopping habits can be quantified. For instance if the user spends the first 20 minutes looking at hard rock artists, and then makes a selection, the system can provide subtle prompting via sidebar menu items for links to artists or songs that other people recently purchased in tandem with the user's most recent selection. Statistics and information can thus be gathered that can be used to further enhance the user's shopping experience as well as subtly prompt the user towards other relevant items.

After the user has made selections, each of the files physically resides within the music database, and the user can also have earned credits in BANDBUCKS or other incentives. After the system has calculated at 212 and prompted them of their earnings, it can give them a list of relevant promotional items on which that BANDBUCKS credit can be spent. Of those promotional items, one of them may be a behind the scenes video clip of one of the artists whose music they just selected actually recording that track in the studio. Next, the user can be allowed to preview several graphics that can be used as a cover and background image for their CD sleeve, such as the image of one of the artists in their selection to cover the entire front of the CD sleeve, a montage option (such as one that will place an image from each music file they selected in a grid layout or pre-made arrangement, such as three across or three down), or other suitable images.

Once checkout is selected at 214, if the user's credit card is on file it can be automatically deducted for the amount that they have spent. Or, perhaps the user has previous BANDBUCKS credits still in their “Bank” (this credit information would reside on the BANDBUCKS server), and the system can check to ensure that the user does indeed have a valid payment option available and then triggers the payload creation process.

Essentially up until now the user has been creating a shopping list of sorts. Each of these items resides on a separate media database, which can be accessed by the main compositing servers. The server is then at 216 responsible for gathering each piece of media, integrating it into the payload file, checking the file for integrity (quality assurance) and then placing the file on the front end Web Server so that the user can click on a server generated link and download their payload file.

Obviously, the number of files that the user has selected will determine the size of the payload file itself. When the user sets up their account one of the questions should be to determine how fast an Internet connection the user has. The actual speed could be determined by running a test using a simple Java applet or some other means. The reason for testing the user's speed is so that suggestions can be made while the user is composing their payload file. If the user selects so many files that the cumulative download will end up being rather long, the system should be able to prompt the user and inform them that if they do not wish to stay connected or online long enough to download the file that they can do so at a later time or perhaps partially download the file and then pick up where they left off later. This service is certainly tailored towards users with broadband connectivity to the Internet. Modem users, or rather dial-up users can certainly still utilize the system, however the download times will be long considering that a standard 3½ minute song, coded at 128 kbps will be around 3.5 MB. Availability of higher bit rate music files should exist so that the user's sound quality remains high.

While the payload file is downloading at 218 a message should be displayed for the user, prompting them to place a CD sleeve template in their printer and a blank CD in their burner (if they have one). However, It is reasonable to imagine that some users will not be looking to burn a CD of this music immediately. Some users may just want to load these MP3's into their MP3 player and forego creating a CD. The extra media or bonus footage that they have purchased with their BANDBUCKS credits should be viewable directly on the computer if indeed they have chosen not to actually create the CD and sleeve.

Once the payload file has been delivered successfully, the user may be prompted to shut down their Web browser (if CD burning and printing take up to many system resources) and any other unnecessary open programs. The user then double-clicks on the executable payload file, and is reminded to place blank media in both the printer and CD burner. Then the media creation process begins. If a printer has already been successfully installed on the computer, then all of the necessary drivers for this process should be in place. The CD burner will also need to conform to a general specification, which is already widely accepted and utilized. There will undoubtedly be the specific cases where for some reason there is an incompatibility, and vigorous in-house testing of multiple platforms in multiple scenarios under different degrees of CPU strain and system resources deficiencies should help to create a useful system troubleshooter which should be readily available should the user need help or prompting.

Once the CD sleeve template is printed, the user should be able to remove it from the printer, tear off excess paper, fold on the necessary creases and then peel away a small adhesive strip, which will make the two sides of the template stick. A document and diagram outlining some potential template designs will be accompanying this document in its final revision. At this point the CD burner will eject the completed CD and the user can label it appropriately and slide into their new custom CD sleeve. Product delivered.

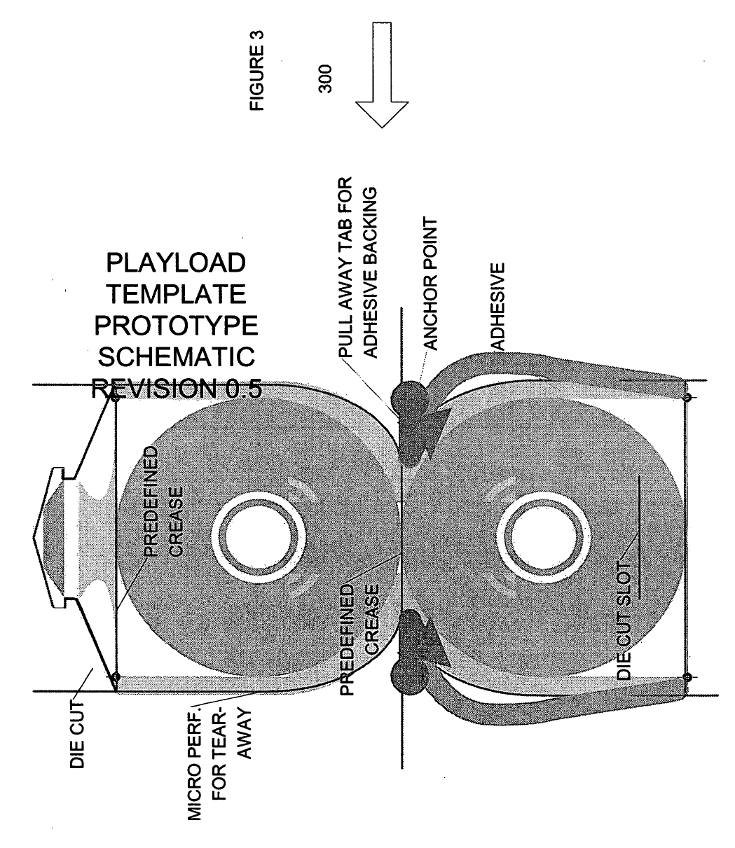

FIG. 3 is a diagram of packaging 300 in accordance with an exemplary embodiment of the present invention. Packaging 300. Packaging 300 as shown is the initial template configuration.

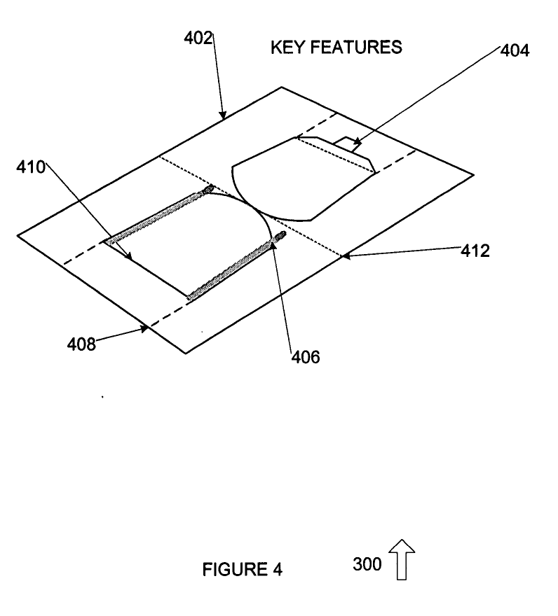

FIG. 4 is a diagram of packaging 300 in accordance with an exemplary embodiment of the present invention. Packaging 300 as shown includes various key features, including: 402 the template is made of thin plastic, and one side is slightly textured for printing (the side without adhesive); 404 areas where there are complex corners are pre-cut for easy removal of surrounding material; 406 the adhesive backing travels beyond the perforations and is fixed onto the discardable portion to allow the backing to be removed along with the discardable portion in one easy step; 408 the continuation of these perforations act as a tear-away path for the left over material as well as aid in the adhesive bonding process (see step 3); 410 most portions of the template are simply perforated; and 412 these pre-stressed fold points aid in the ease of construction.

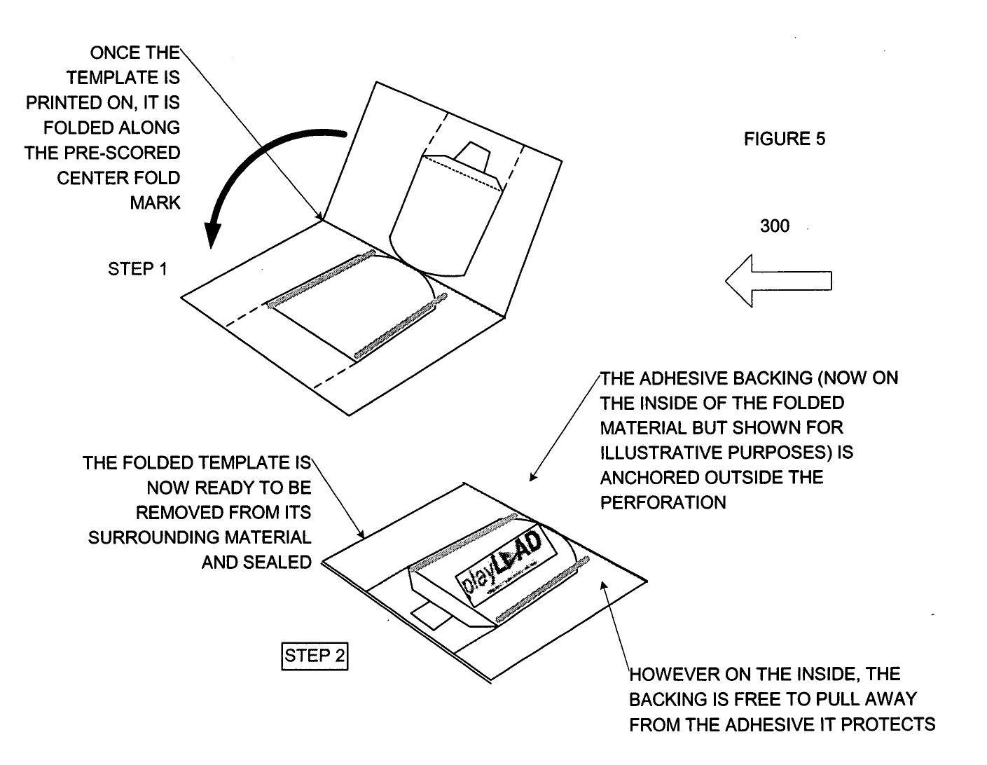

FIG. 5 is a diagram of packaging 300 in accordance with an exemplary embodiment of the present invention, showing the first two steps for assembling the packaging.

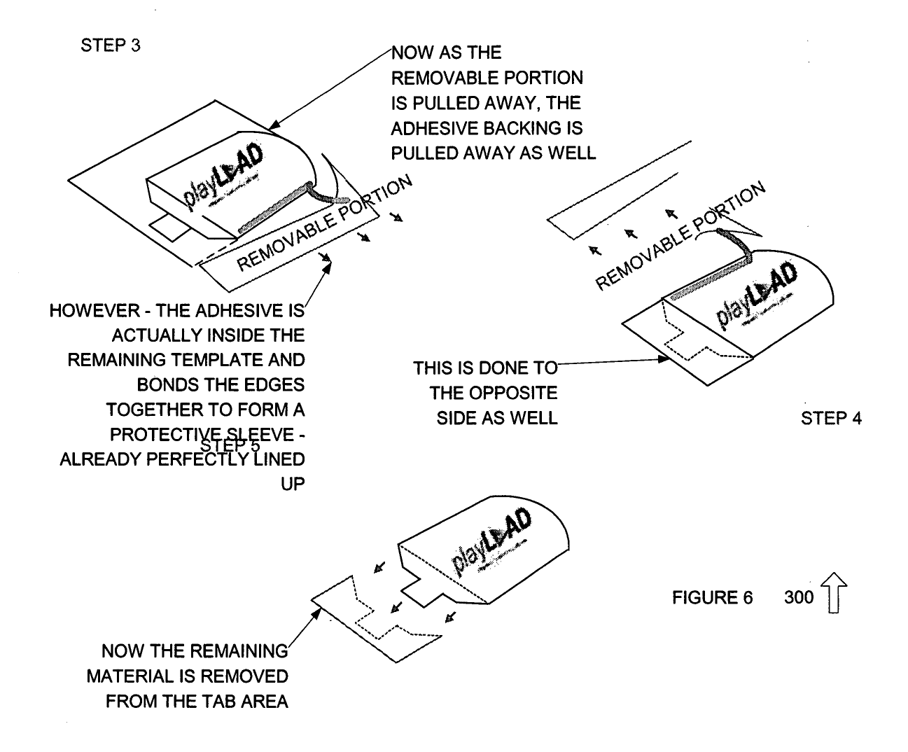

FIG. 6 is diagram of packaging 300 in accordance with an exemplary embodiment of the present invention, showing the next three steps for assembling the packaging.

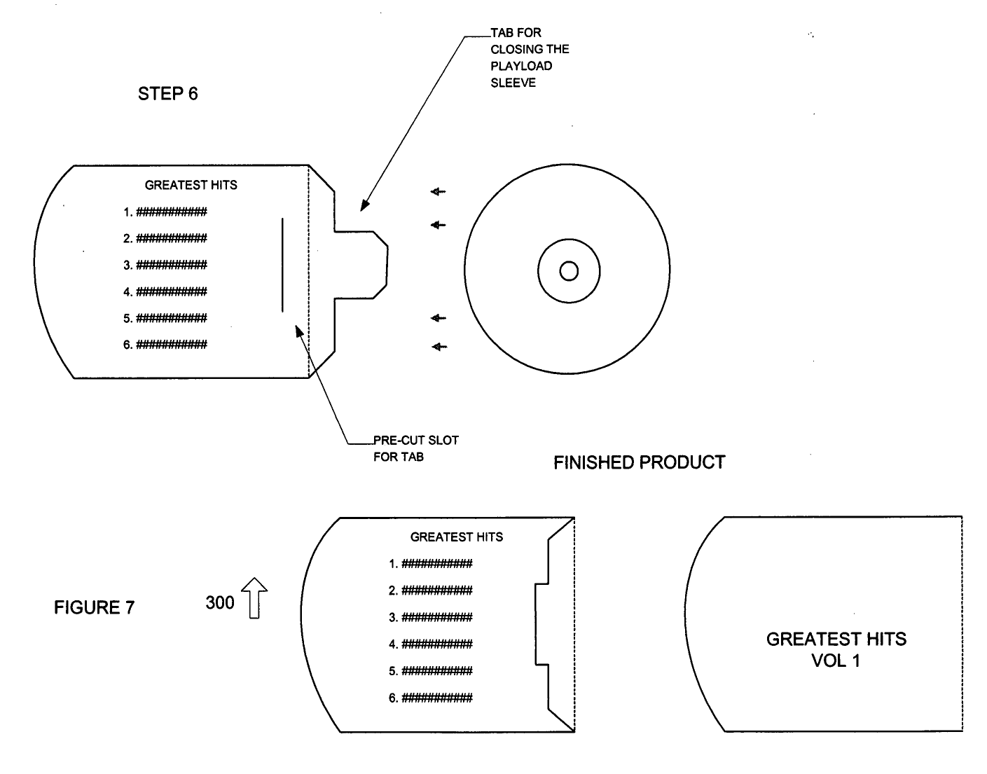

FIG. 7 is diagram of packaging 300 in accordance with an exemplary embodiment of the present invention, showing the last two steps for assembling the packaging.

Although exemplary embodiments of a system and method of the present invention been described in detail herein, those skilled in the art will also recognize that various substitutions and modifications can be made to the systems and methods without departing from the scope and spirit of the appended claims.

1. A system for delivering content comprising:
a content selection system receiving one or more content selections from a user and assembling the content selections;
a content delivery system assembling the content selections with one or more content deployment system; and
wherein the content selections and the content deployment systems are delivered as an integrated unit.

2. The system of claim 1 wherein the content deployment system includes a jewel case cover printer system.

3. The system of claim 1 wherein the content deployment system includes a CD burner system.

4. The system of claim 1 wherein the content deployment system includes a DVD burner system.

5. The system of claim 1 wherein the content deployment system includes a memory device cover printer system.

6. The system of claim 1 wherein the content deployment system includes a multimedia player delivery system.
